(19) United States
(12) Patent Application Publication
(10) Pub. No.: US 2011/0205843 A1
(43) Pub. Date: Aug. 25, 2011

(54) METHOD OF PROCESSING SEISMIC DATA

(76) Inventor: Vard Albert Nelson, Fairplay, CO (US)

(21) Appl. No.: 12/712,127

(22) Filed: Feb. 24, 2010

(51) Int. Cl. G01V 1/00

(52) U.S. Cl. 367/38

(57) ABSTRACT

One or more methods and systems for processing seismic data to improve resolution of seismic images are provided. In one or more embodiments the method can include constructing a plurality of ray path traces. Each ray path trace can have a first portion for a first vertical location and a second portion for a second vertical location. An impinging angle for each ray path trace is held constant for the first vertical location and the second vertical location.

### FIELD

The present embodiments generally relate to a method and system for processing seismic data to improve resolution of seismic images.

### BACKGROUND

A need exists for a method of processing seismic data that increases resolving power in an efficient and accurate way.

A further need exists for a method and system of processing seismic data that enables better accuracy and identification of hydrocarbon reservoirs.

The present embodiments meet these needs.

### BRIEF DESCRIPTION OF THE DRAWINGS

The detailed description will be better understood in conjunction with the accompanying drawings as follows:

FIG. 1 depicts a schematic representation of a ray path trace according to one or more embodiments.

FIG. 2 depicts a second ray path trace where the impinging angle for a first portion and a second portion are equal to one another but are at an angle different from the ray path trace of FIG. 1.

FIG. 3 depicts an illustrative gather of acquired seismic data representing a common reflection point according to one or more embodiments.

FIG. 4 depicts an illustrative chart of ordered interpolated values according to one or more embodiments.

FIG. 5 depicts an illustrative system for processing seismic data to improve resolution of seismic images.

The present embodiments are detailed below with reference to the listed Figures.

### DETAILED DESCRIPTION OF THE EMBODIMENTS

Before explaining the present method and system in detail, it is to be understood that the method and system are not limited to the particular embodiments and that they can be practiced or carried out in various ways.

The present embodiments relate to a method and system for processing seismic data to improve resolution of seismic images. An image as used herein can be a graph, a three-d volume, a 2-d volume, a multi-dimensional matrix of values, or other product of processed seismic data commonly known in the art.

One or more embodiments of the method to process seismic data to improve resolution of seismic images can include constructing a plurality of ray path traces. The ray path traces can have a first portion associated with a first vertical location and a second portion associated with a second vertical location. The ray path traces can represent propagating signals. The propagating signals can be compression waves, shear waves, or combinations thereof.

An impinging angle for each ray path trace can be held constant for the first vertical location and the second vertical location. The impinging angle can be measured from a vertical axis or one or more horizontal axes. The impinging angle can range from about 0 degrees to about 90 degrees.

As the impinging angle is held constant for each ray path and vertical location, a vertical travel time for each ray path trace can be calculated. For example, the vertical travel time can be determined using the impinging angle and the interval time. For example, a trigonometry function, such as the law of cosine, law sine, or law of tangents, can be used to determine the vertical travel time. The interval time can be a period of signal activity after initiation of the signal. The interval time can range from 1 ms to 16 ms.

An offset for each ray path having the common impinging angle for the first portion and second portion thereof can be determined. For example, a trigonometry function, such as the law of cosine, law sine, or law of tangents, can be used to determine the offset. The offset can be equal to the vertical distance times the tangent of the impinging angle when the impinging angle is measured from the vertical axis. The vertical distance can be equal to the vertical travel time multiplied by the velocity of the signal through the earth.

The method can use the determined offset and determined vertical time to acquire a signal value from a gather of acquired seismic data representing a common reflection point. The gather of acquired seismic data representing a common reflection point can include a plurality of measured or acquired traces. The gather of acquired seismic data representing a common reflection point can be a common midpoint gather, a common reflection point gather, or common depth point gather. The signal value can be acquired by interpolating the gather of acquired seismic data representing a common reflection point to determine a signal value for each determined offset and vertical time. The interpolation can be any commonly used interpolation, such linear interpolation or hyperbolic interpolation.

The method can be performed using a system. The system can include a processor in communication with a data storage. The data storage can include a plurality of computer instructions.

The data storage can include computer instructions for constructing a plurality of ray path traces, wherein each ray path trace can have a first portion for a first vertical location and a second portion for a second vertical location, and wherein an impinging angle for each ray path trace can be held constant for the first vertical location and the second vertical location.

The data storage can also include computer instructions for determining a vertical time for each ray path trace.

The data storage can also have computer instructions for determining an offset for each portion of each ray path, and interpolating a signal value from the gather of acquired seismic data representing a common reflection point to acquire an interpolated signal value for the determined time and determined offset of each ray path trace.

The data storage can further include computer instructions for generating a data processing product. The data processing product can include at least one of a stack of the interpolated signal values, a statistical analysis of the interpolated signal values, a trend analysis, or other seismic processing result or product used in the art. For example, the statistical analysis can include a trend analysis, such as amplitude versus angle.

The data storage can also include computer instructions for manipulating the interpolated signal values. The manipulation of the interpolated signal values can be used to generate the processing product.

The acquired seismic data can be measured using two way travel time or using other methods commonly known in the art.

The acquired data can be measured using a plurality of source events and a plurality of receivers. Each source event can be located at an independent constant location. Each receiver can be located at an independent constant location. For example, a first source event, a second source event, and a third source event can be located at a first source event location, a second source event location, and a third source event location respectively. The source event locations can remain constant during the acquisition of the data. Similarly, a first receiver, a second receiver, and a third receiver can be located at a first receiver location, a second receiver location, and a third receiver location, and the receiver locations can remain constant through out the acquisition of the seismic data.

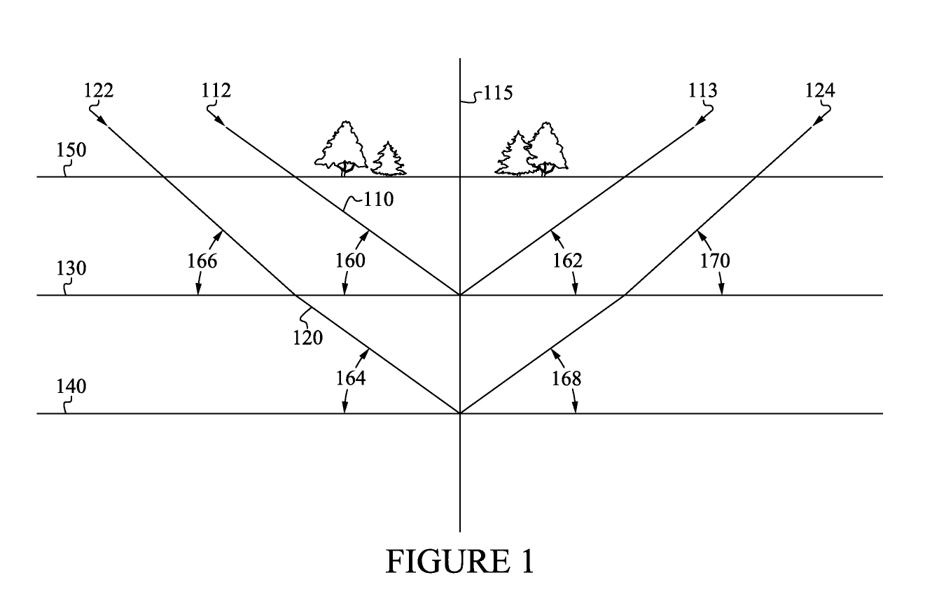

FIG. 1 depicts a schematic representation of a ray path trace according to one or more embodiments. The ray path trace can include a first portion 110 and a second portion 120.

The first portion 110 can be formed by a ray path vector 112 traveling from the earth's surface 150 to a first vertical location 130 and from a second ray path vector 113 traveling from the first vertical location 130 to the earth's surface 150. The first ray path vector 112 can travel at a first impinging angle 160. The second ray path vector 113 can also have a first re-emission angle 162 that is equal to the first impinging angle 160. The first re-emission angle 162 can be small or larger than the first impinging angle 160.

The second portion 120 can be formed by a third ray path vector 122 traveling from the earth's surface 150 to a second location 140 and a fourth ray path vector 124 traveling from the second vertical location 140 to the earth surface 150.

The second portion 120 can include the portion of the third ray path vector 122 from the first vertical location 130 to the second vertical location 140, and the portion of the fourth ray path vector 124 from the second vertical location 140 to the first vertical location 130. The second portion 120 can have a second impinging angle 164.

As such, the third ray path vector 122 travels at the second impinging angle 164 from the first vertical 130 location to the second vertical location 140, and can travel at a third impinging angle 166 from the earth's surface 150 to the first vertical location 130. The third impinging angle 166 can be the same as, larger than, or smaller than the second impinging angle 164 depending on the difference in rock velocity from the earth's surface 150 to the first vertical location 130 and from the first vertical location 130 to the second vertical location 140. The second impinging angle 164 is held constant to the first impinging angle 160.

The fourth ray path vector 124 can also have a second re-emission angle 168 that is the same as, smaller than, or larger than the second impinging angle 164. The fourth ray path vector 124 can also have a third re-emission angle 170 that is equal to, larger than, or smaller than the second re-emission angle 168.

The first ray path trace first portion 110 and second portion 120 can have a common midpoint 115.

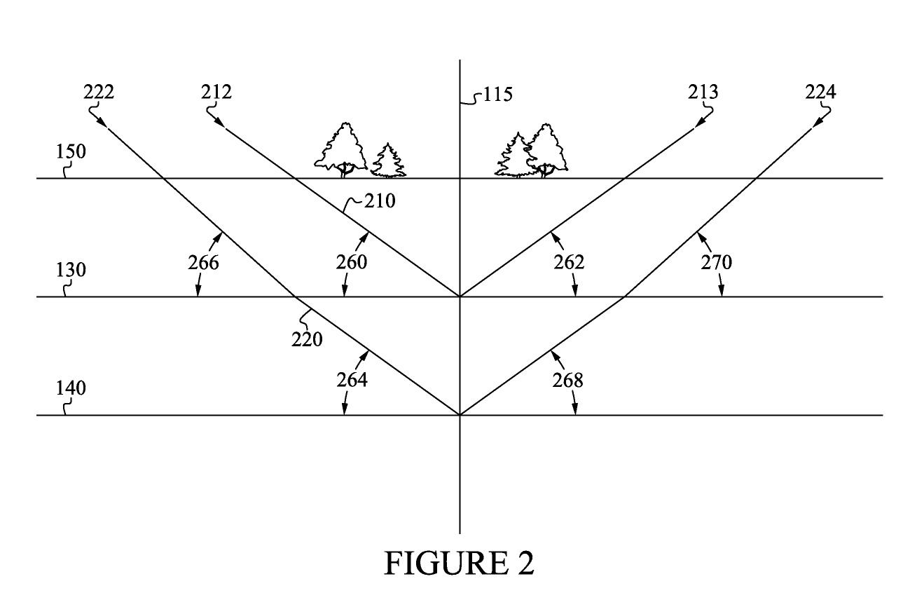

FIG. 2 depicts a second ray path trace where the impinging angle for a first portion 210 and a second portion 220 are equal to one another but are at an angle different from the ray path trace of FIG. 1.

The second ray path trace first portion 210 can be formed by a fifth ray path vector 212 traveling from the earth's surface 150 to the first vertical location 130 and from a sixth ray path vector 213 traveling from the first vertical location 130 to the earth's surface 150. The fifth ray path vector 212 can travel at a fourth impinging angle 260. The sixth ray path vector 213 can also have a fourth re-emission angle 262 that is equal to the fourth impinging angle 260. The fourth re-emission angle 262 can be smaller or larger that the fourth impinging angle 260.

The second portion 220 can be formed by a seventh ray path vector 222 traveling from the earth's surface 150 to a second vertical location 140 and a eighth ray path vector 224 traveling from the second vertical location 140 to the earth surface 150.

The second portion 220 can include the portion of the seventh ray path vector 222 from the first vertical location 130 to the second vertical location 140, and the portion of the eighth ray path vector 224 from the second vertical location 140 to the first vertical location 130. The second portion 220 can have a fifth impinging angle 264. The fifth impinging angle 264 is equal to the fourth impinging angle 260.

The seventh ray path vector 222 can have the fifth impinging angle 264 from the first vertical location 130 to the second vertical location 140, and a sixth impinging angle 266 from the earth's surface 150 to the first vertical location 130. The fifth impinging angle 266 can be the same as, larger than, or smaller than the sixth impinging angle 264 depending on the difference in rock velocity from the earth's surface 150 and the first vertical location 130 and from the first vertical location 130 and the second vertical location 140.

The eighth ray path vector 224 can also have a fifth re-emission angle 268 that is same as, smaller than, or larger than the fifth impinging angle 264. The fourth ray path vector 224 can also have a sixth re-emission angle 270 that is equal to, larger than, or smaller than the fifth impinging angle 268.

The second ray path trace first portion 210 and second portion 220 can also have a common midpoint 115.

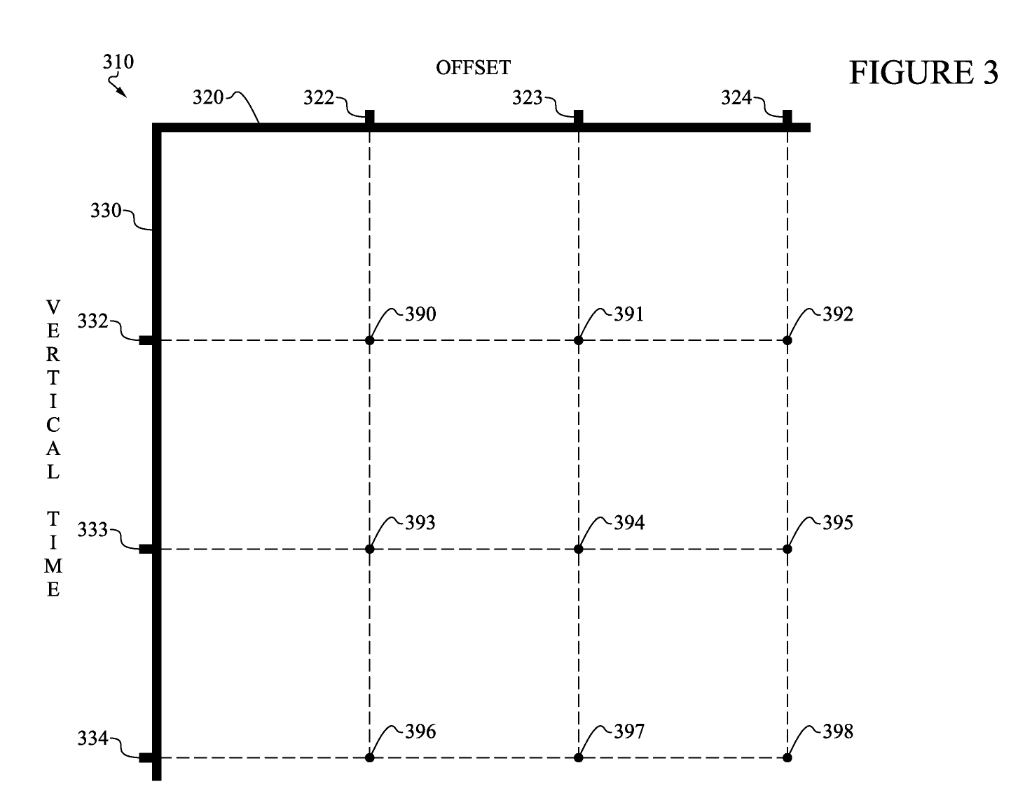

FIG. 3 depicts an illustrative gather of acquired seismic data for a common reflection point according to one or more embodiments.

The gather of acquired seismic data 310 can include an offset axis 320, a vertical time axis 330, and a plurality of signal values (nine are shown 390, 391, 392, 393, 394, 395, 396, 397, and 398).

The offset axis 320 can have a plurality of points (three are shown 322, 323, and 324) which represent offset positions, such as horizontal distance along the earth's surface, from a midpoint.

The time axis 330 can include a plurality of points (three are shown as 332, 333, and 334) which can represent a vertical time of travel.

A first signal 390 can be associated with points 322 and 332. A second signal 391 can be associated with points 323 and 332. A third signal 392 can be associated with points 324 and 332.

A fourth signal 393 can be associated with points 322 and 333, a fifth signal 394 can be associated with points 323 and 333, and a sixth signal 395 can be associated with points 324 and 333.

A seventh 396 can be associated with points 322 and 334, an eighth signal 397 can be associated with points 323 and 334, and a ninth signal 398 can be associated with points 324 and 334.

In operation, a plurality of constant impinging angles can be used to form a plurality of ray path traces and the calculated offsets and vertical times can be used to extract a plurality of signal strengths from a measured gather of acquired seismic data representing a common reflection point. For clarity, the process will be described using the ray path traces depicted in FIG. 1 and FIG. 2 and the gather of acquired seismic data representing a common reflection point ordered chart of FIG. 3.

The offset for the ray path trace of FIG. 1 can be determined by picking an interval time, usually matching an interval time from field measurements, and calculating the Vertical time. For example, the Vertical travel time for ray path 212 can be equal to the sine of the impinging angle 260 times 0.5 interval time [Vertical time=sine (impinging angle 260)*0.5 interval time]. The Vertical time for each ray path vector 112, 113, 122, 124, 212, 213, 222, and 224 can be calculated in a similar fashion.

Accordingly, the Vertical time for the first portions 110, 210 and the second portions 120, 220 can be determined using trigonometry, the constant impinging angle, the rock velocity, and one or more known interval times.

In addition, the offset for each ray path can be calculated. The offset can be equal to the distance from the midpoint 115 to one or more points along the ray path vectors 112, 113, 122, 124, 212, 213, 222, and 224. For example, the offset for an end of the ray path vector 212 at the earth's surface 150 can be equal to the Vertical time for ray path vector 212 times the rock velocity that the ray path vector 212 is traveling through divided by the tangent of impinging angle 260 [Offset=Vertical time*rock velocity/(tangent of impinging angle 260].

The offset for an end of the ray path vector 122 at the earth's surface 150 can be equal to the Vertical time for ray path vector 122 times the rock velocity that the ray path vector 122 is traveling through between the earth's surface 150 and the first vertical location 130 divided by the tangent of impinging angle 166 plus the rock velocity that the ray path vector 122 is traveling through between the second vertical location 140 and the first vertical location 130 divided by the tangent of impinging angle. [Offset=(Vertical time*rock velocity between earth's surface and the first vertical location/(tangent of impinging angle 166))+(Vertical time*rock velocity between second vertical location and the first vertical location/(tangent of impinging angle 164))].

Accordingly, the offset for the first portions 110, 210 and the second portions 120, 220 can be determined using the known interval times, rock velocity, and trigonometry.

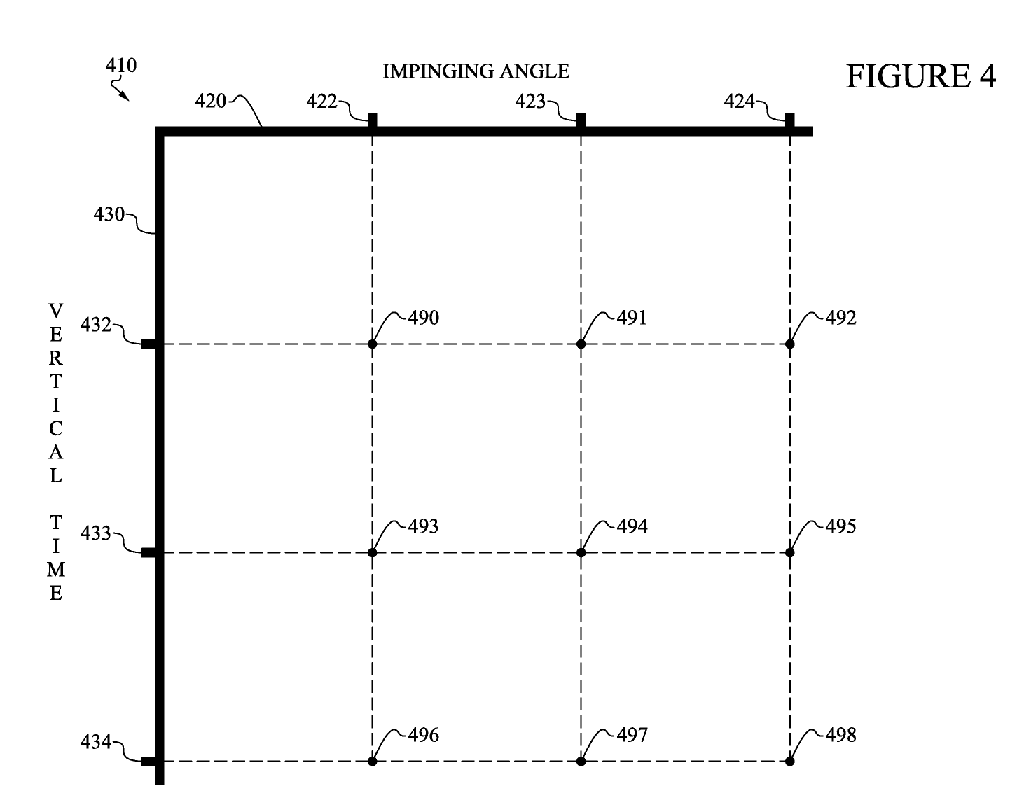

Once values are achieved for the offsets and Vertical times of the first portions 110 and 210, and second portions 120 and 220 are achieved an interpolated signal value can be extracted from the gather of acquired seismic data representing a common reflection point chart of FIG. 3. The interpolated signal values can be ordered into another chart. For example, the data can be organized, as depicted in FIG. 4, in a chart having a first axis of impinging angles and a second axis of vertical time.

FIG. 4 depicts an illustrative chart of ordered interpolated values according to one or more embodiments. The illustrative chart of ordered interpolated values 410 can include a first axis 420, associated with constant impinging angles, and a second axis 430 equal to vertical time. The interpolated signal values (nine are shown 490, 491, 492, 493, 494, 495, 496, 497, and 498) can be associated with different values or points along the first axis 420 and the second axis 430.

The impinging angle axis 420 can have a plurality of points (three are shown 422, 423, and 424) which represent impinging angles.

The time axis 430 can include a plurality of points (three are shown as 432, 433, and 434) which can represent a vertical time of travel.

A first signal 490 can be associated with points 422 and 432. A second signal 491 can be associated with points 423 and 432. A third signal 492 can be associated with points 424 and 432.

A fourth signal 493 can be associated with points 422 and 433, a fifth signal 494 can be associated with points 423 and 433, and a sixth signal 495 can be associated with points 424 and 433.

A seventh signal 496 can be associated with points 422 and 434, an eighth signal 497 can be associated with points 423 and 434, and a ninth signal 498 can be associated with points 424 and 434.

The interpolated signal values 490, 491, 492, 493, 494, 495, 496, 497, and 498 can now have a greater resolving power because there is a greater time difference therebetween. Accordingly, when the interpolated signal values 490, 491, 492, 493, 494, 495, 496, 497 are summed or otherwise manipulated the resulting images are more clear or depict a greater resolved detail than images obtained by manipulating data as acquired in the field.

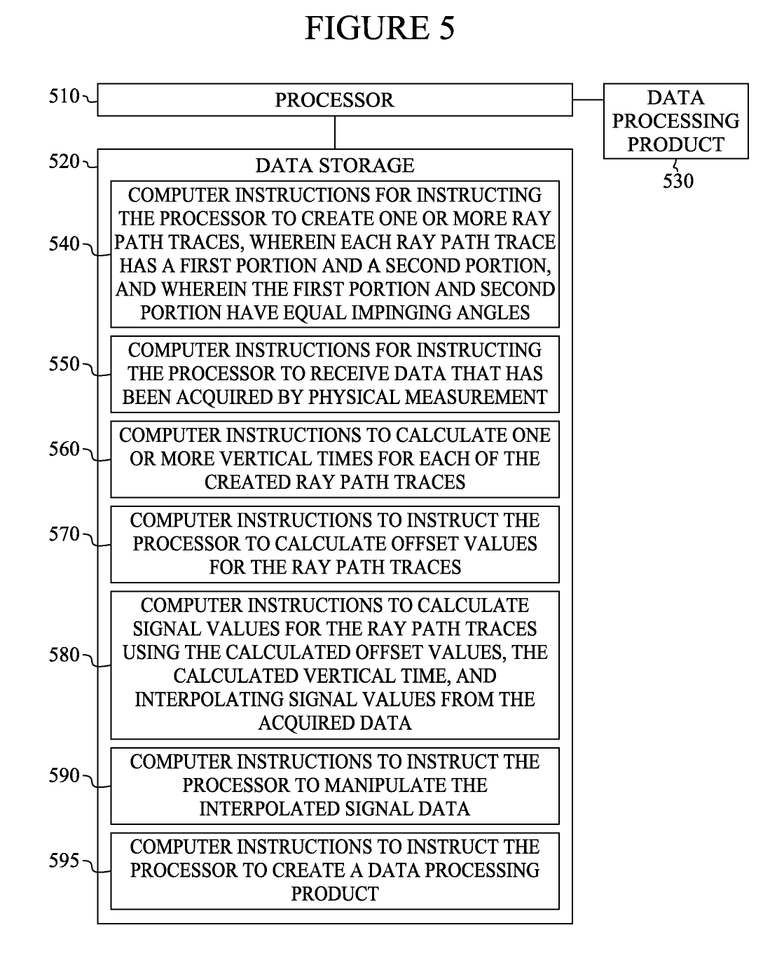

FIG. 5 depicts an illustrative system for processing seismic data to improve resolution of seismic images. The system can include a processor 510, a data storage 520, and one or more computer instructions (seven are shown 540, 550, 560, 570, 580, 590, 595) stored on the data storage 520.

The processor 510 can be a commercially available processor, such as a Pentium 3 processor. The data storage 520 can be online data storage, such as a server in communication with the processor 510 over a network; portable data storage, such as a flash drive, an external hard drive or a compact disk; or imbedded data storage, such as an internal hard drive.

First computer instructions 540 can be for instructing the processor to create one or more ray path traces, wherein each ray path trace has a first portion and a second portion, and wherein the first portion and second portion have equal impinging angles.

Second computer instructions 550 can be for instructing the processor to receive data that has been acquired by physical measurement. The second computer instructions 550 can instruct the processor to receive the acquired data in an ordered form, such as a chart, table or graph, or the second computer instructions 550 or additional computer instructions (not shown) can be used to order the acquired data.

Third computer instructions 560 can be used to calculate one or more vertical times for each of the created ray path traces. For example, the vertical times can be calculated as discussed herein.

Fourth computer instructions 570 can instruct the processor 510 to calculate offset values for the ray path traces. The offset values can be calculated as discussed herein.

Fifth computer instructions 580 can be used to calculate signal values for the ray path traces using the calculated offset values, the calculated vertical time, and interpolating signal values from the acquired data.

Sixth computer instructions 590 can be used to instruct the processor to manipulate the interpolated signal data. For example, the sixth computer instructions can at least one of order the interpolated signal values based on impinging angle and vertical time; sum the signal values, or perform other types of signal or data manipulation.

Seventh computer instructions 595 can be used to instruct the processor to create a data processing product 530.

While these embodiments have been described with emphasis on the embodiments, it should be understood that within the scope of the appended claims, the embodiments might be practiced other than as specifically described herein.

What is claimed is:

1. A method of processing seismic data to improve resolution of seismic images comprising:
a. constructing a plurality of ray path traces, wherein each ray path trace has a first portion for a first vertical location and a second portion for a second vertical location, and wherein an impinging angle of the first portion is equal to an impinging angle of the second portion;
b. determining a vertical time for each ray path trace;
c. determining an offset for each ray path trace; and
d. interpolating a signal value from a gather of acquired seismic data representing a common reflection point to acquire an interpolated signal value for the determined time and determined offset of each ray path trace.

2. The method of claim 1, wherein the gather of acquired seismic data is acquired using shear waves, compression waves, or combinations thereof.

3. The method of claim 1, wherein the each impinging angle ranges from 0 degrees to 90 degrees.

4. The method of claim 1, wherein the gather of acquired seismic data is a common midpoint gather, a common reflection point gather, or common depth point gather.

5. A system for processing seismic data to improve resolution of seismic images comprising:
a. a processor; and
b. data storage in communication with the processor, wherein the data storage comprises computer instructions for:
(i) constructing a plurality of ray path traces, wherein each ray path trace has a first portion for a first vertical location and a second portion for a second vertical location, and wherein an impinging angle of the first portion is equal to an impinging angle of the second portion;
(ii) determining a vertical time for each ray path trace;
(iii) determining an offset for each ray path trace; and
(iv) interpolating a signal value from a gather of acquired seismic data representing a common reflection point to acquire an interpolated signal value for the determined time and determined offset of each ray path trace.

6. The system of claim 5, wherein the gather of acquired seismic data representing a common reflection point is acquired using shear waves, compression waves, or combinations thereof.

7. The system of claim 5, wherein each impinging angle ranges from 0 degrees to 90 degrees.

8. The system of claim 5, wherein the data storage further comprises computer instructions for generating a data processing product.

9. The system of claim 8, wherein the data processing product includes at least one of a stack of the interpolated signal values, a statistical analysis of the interpolated signal values, and a trend analysis.

10. The system of claim 5, wherein the data storage further comprises computer instructions for manipulating the interpolated signal values.

11. The system of claim 10, wherein the manipulation of the interpolated signal values includes at least one of a stack of the interpolated signal values, a statistical analysis of the interpolated signal values, and a trend analysis.

12. The system of claim 10, wherein the gather of acquired seismic data representing a common reflection point is a common midpoint gather, a common reflection point gather, or common depth point gather.

13. The system of claim 10, wherein the acquired seismic data is measured in a two way travel time.

14. The system of claim 10, wherein the acquired data is measured using a plurality of source events and a plurality of receivers.

15. The system of claim 14, wherein each source event is located at an independent constant location.

16. The system of claim 14, wherein each receiver is located at an independent constant location.
